(19) United States
(12) Patent Application Publication
(10) Pub. No.: US 2020/0026943 A1
(43) Pub. Date: Jan. 23, 2020

(54) SYSTEM AND METHOD FOR IDENTIFICATION AND PRIORITIZATION OF ONE OR MORE ATTRIBUTES IN AN IMAGE

(71) Applicant: Vidit, LLC, Layton, UT (US)

(72) Inventors: Rene Rodriguez, Layton, UT (US); George Michael Theodore, Greensboro, NC (US); Rodrigo Moya, Layton, UT (US)

(21) Appl. No.: 16/506,763

(22) Filed: Jul. 9, 2019

Related U.S. Application Data
(60) Provisional application No. 62/699,517, filed on Jul. 17, 2018.

(51) Int. Cl. G06K 9/00; G06K 7/14; G06K 9/46; G06K 9/62

(52) U.S. Cl. CPC G06K 9/00979; G06K 9/00228; G06Q 50/01; G06K 9/4633; G06K 9/6278; G06K 7/1404

(57) ABSTRACT

A system and method for identification and prioritization of one or more attributes is provided. The system includes an image processing subsystem configured to receive a scanned image from a scanning device. The image processing subsystem is also configured to process the scanned image using one or more image processing techniques. The system also includes an identification subsystem coupled to the image processing subsystem. The identification subsystem is configured to identify one or more attributes from a processed image, where the one or more attributes includes a barcode or an image. The system or method further includes a prioritization subsystem coupled to the identification subsystem. The prioritization subsystem is configured to prioritize one or more identified attributes in a predefined order. The system further includes a recognition subsystem coupled to the identification subsystem. The recognition subsystem is configured to recognize a face of a user upon identification of the image.

### CROSS-RELATED APPLICATIONS

This application claims priority to United States Provisional Patent Application No. 62/699,517 which was filed Jul. 17, 2018.

### BACKGROUND

A social media platform engages individuals, communities, and organizations to share, co-create, discuss, and modify user-generated content or pre-made content posted online.

### SUMMARY

Embodiments of the present invention scan an image or interactive image to extract meaningful information from the image. Such information may be recognition of a portion of an image as a barcode, a coded tag, facial recognition or other features that may be compared to a lookup table to identify features of a scanned image such as a location, landmark, building, artwork or person.

In accordance with an embodiment of the present disclosure, a system for identification and prioritization of one or more attributes if a scanned image is provided. The system includes an image processing subsystem configured to receive a scanned image from a scanning device or camera or from any image capture or delivery system. The image processing subsystem is also configured to process the scanned image using one or more image processing techniques. The system also includes an identification subsystem coupled to the image processing subsystem. The identification subsystem is configured to identify one or more attributes from a processed image, wherein the one or more attributes includes a barcode, a coded tag or message or specific features of an image. The system further includes a prioritization subsystem coupled to the identification subsystem. The prioritization subsystem is configured to prioritize one or more identified attributes in a predefined order. In one embodiment, the system further includes a recognition subsystem coupled to the identification subsystem. The recognition subsystem is configured to recognize a face of a user upon identification of the image.

In accordance with another embodiment of the present disclosure, a method for identification and prioritization of one or more attributes is provided. The method includes receiving a scanned image and analysing the image. The method also includes processing the scanned image using one or more image processing techniques. The method further includes identifying one or more attributes from a processed image. The method further includes recognizing a face as one of the attributes which may then be further analysed to identify an individual. The method further includes prioritizing one or more identified attributes in a predefined order.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram of a system for identification and prioritization of one or more attributes in accordance with an embodiment of the present disclosure;

FIG. 2 is a block diagram of an exemplary embodiment the system for identification and prioritization of the one or more attributes of FIG. 1 in accordance with an embodiment of the present disclosure; and

FIG. 3 is a flow chart representing the steps involved in a method of identification and prioritization of the one or more attributes of FIG. 1 in accordance with an embodiment of the present disclosure.

Further, those skilled in the art will appreciate that elements in the Figures are illustrated for simplicity and may not have necessarily been drawn to scale. Furthermore, in terms of the construction of the device, one or more components of the device may have been represented in the figures by conventional symbols, and the Figures may show only those specific details that are pertinent to understanding the embodiments of the present invention so as not to obscure the figures with details that will be readily apparent to those skilled in the art having the benefit of the description herein.

### DETAILED DESCRIPTION OF THE PREFERRED EMBODIMENTS

For the purpose of promoting an understanding of the principles of the invention, reference will now be made to embodiments illustrated in the Figures and specific language used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying Figures.

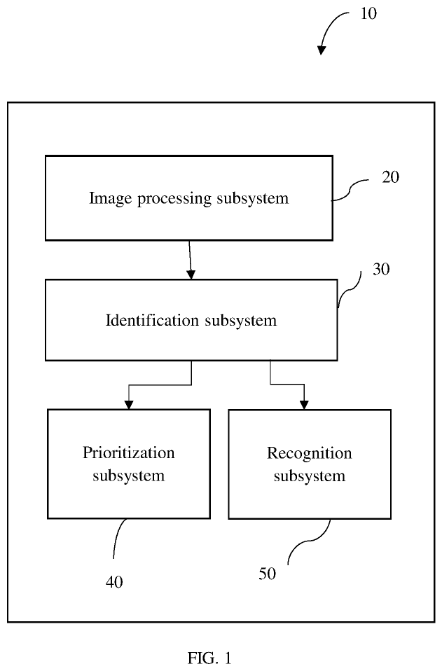

FIG. 1 is a block diagram of a system 10 for identification and prioritization of one or more attributes in accordance with an embodiment of the present disclosure. The system 10 includes an image processing subsystem 20 configured to receive a scanned image. In one embodiment, the image may be received from a scanning device which may be a mobile phone or a web camera. The image processing subsystem 20 is also configured to process the scanned image using one or more image processing techniques. In some embodiments, the one or more image processing techniques may include an edge detection technique, a Hough transformation technique or a Bayesian technique.

Furthermore, system 10 also includes an identification subsystem 30 coupled to the image processing subsystem 20. The identification subsystem 30 is configured to identify one or more attributes from a processed image. The one or more attributes may include a barcode or an image. As used herein the term “barcode” is defined as an optical, machine-readable representation of data. The data usually describes something about the object that carries the barcode. In a specific embodiment, the barcode may include one dimensional barcode or a two-dimensional bar code such as quick response (QR) code.

In operation, the identification of a QR code in the processed image is performed by first segmenting the processed image which searches for a barcode region. Furthermore, a grayscale method is applied to convert a segmented image into grayscale. The grayscale image is then subject to binarization processing to convert a plurality of pixels of the grayscale image into a binary image. In one embodiment, the identification subsystem 30 further identifies at least three position detection patterns included in the QR code from the image, determined according to the position detection patterns of the QR code in the image of an intersect, and then analyses a plurality of coordinates of the three intersects of the position detection patterns. The Hough transform over the three vertices is applied to determine a fourth intersect, to calculate the boundaries of the QR code which identify that the binary image is a QR code image.

The system 10 further includes a prioritization subsystem 40 coupled to the identification subsystem 30. The prioritization subsystem 40 is configured to prioritize one or more identified attributes in a predefined order. In one embodiment, the predefined order may include a barcode, tag or QR code first and an image last.

In one embodiment, the system 10 further includes a recognition subsystem 50 coupled to the identification subsystem 30. The recognition subsystem 50 is configured to recognize a face upon identification of the image. If the processed image is an image without barcode, tag or QR code, then facial recognition techniques are applied to recognize an identity of the face. In such an embodiment, for the recognition of a face, the recognition subsystem 50 may be configured to determine if a face is present in the image. The recognition subsystem 50 may be further configured to determine a position of a face in the image if face is present. In such an embodiment, the recognition subsystem 50 applies an eye template to a first side of the face and a mirror image of the eye template to a second side of the face. Further, the recognition subsystem 50 may extract at least first and second facial features from the face in accordance with the position. In a specific embodiment, the recognition subsystem 50 may be configured to compare the extracted facial features with reference facial feature data to identify the face.

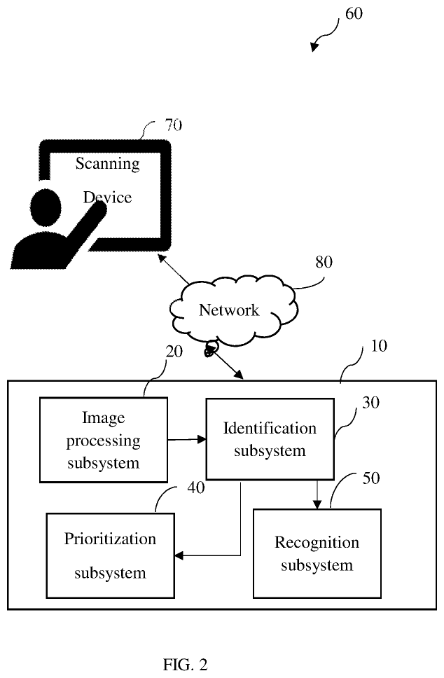

FIG. 2 is a block diagram of an exemplary embodiment 60 the system 10 for identification and prioritization of the one or more attributes of FIG. 1 in accordance with an embodiment of the present disclosure. The exemplary embodiment 60 is related to scanning an image present on a social media platform to identify one or more attributes of the image which further helps in recognizing an identity. A user x scans an interactive image using a scanning device 70 such as mobile phone or a web camera coupled with a computing device. The scanned image is then received by an image processing subsystem 20 via communication network 80. In some embodiments, the communication network 80 may include a wired communication network such as a LAN. In another embodiment, the communication network 80 may include a wireless communication network such as 2G, 3G, 4G, LTE, HSDPA, WiFi, Bluetooth, Zigbee, Low Power WAN and the like. In a specific embodiment, the system 10 may be located on a cloud-based server and accessed remotely by the user. The image processing subsystem 20 then processes the scanned image using one or more image processing techniques.

Furthermore, the system 10 may include an identification subsystem 30 coupled to the image processing subsystem 20. The identification subsystem 30 is configured to identify one or more attributes from a processed image. The one or more attributes includes a barcode, tag, QR code or an image. Based on the image analysis, the system 10 identifies whether the scanned image includes a barcode or a simple image only. The prioritization subsystem 40 further prioritizes the one or more attributes in a predefined order for example, the identification search result may be prioritized in an order such as the first priority is assigned to the barcode and the last priority is assigned to the image. Whenever, the user searches for an identity the system 10 first provides the barcode and then the image. In another case, if a barcode is not detected in the processed image, then a facial recognition technique is applied to the processed image to identify a face using a recognition subsystem 50.

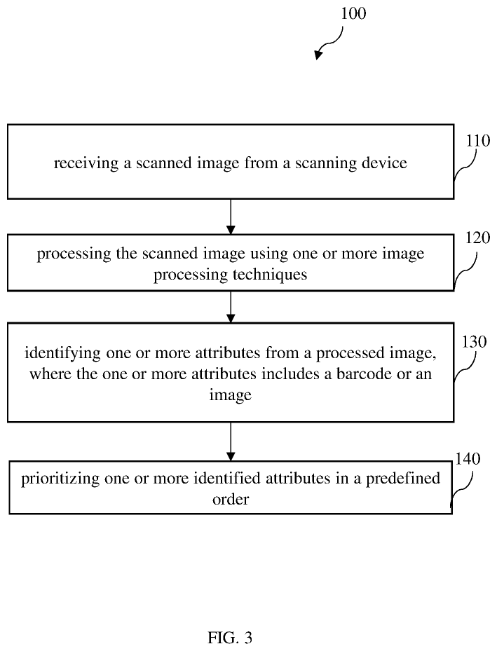

FIG. 3 is a flow chart representing the steps involved in a method 100 of identification and prioritization of the one or more attributes of FIG. 1 in accordance with an embodiment of the present disclosure. The method 100 includes receiving a scanned image from a scanning device in step 110. In one embodiment, receiving a scanned image from a scanning device may include receiving a scanned image from a mobile phone or a web camera. The method 100 also includes processing the scanned image using one or more image processing techniques in step 120. In some embodiments, processing the scanned image using one or more image processing techniques may include processing the scanned image using at least one of an edge detection technique, a Hough transformation technique or a Bayesian technique.

Furthermore, system and method 100 includes identifying one or more attributes from a processed image, where the one or more attributes includes a barcode or an image in step 130. In a specific embodiment, identifying one or more attributes from a processed image may include identifying a barcode such as one-dimensional barcode or a two-dimensional barcode. In such embodiment, identifying the barcode may include identifying a quick response (QR) code. In one embodiment, identifying the QR code may include identifying the QR code by first segmenting the processed image which searches for a barcode region.

Further, the system and method 100 may include applying a grayscale method on a segmented image to convert the segmented image into grayscale. In some embodiments, the method 100 may further include converting a plurality of pixels of the grayscale image into binary image based on binarization process. In a specific embodiment, the method 100 may further include identifying at least three position detection patterns included in the QR code from the image, determined according to the position the at least three detection patterns of the QR code in the image of an intersect, and then analysing a plurality of coordinates of the at least three intersects of the at least three position detection patterns. In such embodiment, identifying the QR code by calculating a fourth intersect based on the Hough transform.

Moreover, the system and method 100 further includes prioritizing one or more identified attributes in a predefined order in step 140. In one embodiment, prioritizing one or more identified attributes in a predefined order may include prioritizing one or more identified attributes in a barcode first and the image last order. In a specific embodiment, the method 100 may include to recognizing a face of a user upon identification of the image. In some embodiments, recognizing the face of the user upon identification of the image may include applying an eye template to a first side of the face and a mirror image of the eye template to a second side of the face. In such embodiment, the method 100 may include extracting at least first and second facial features from the face in accordance with the position. In another embodiment, the method 100 may include comparing the at least two extracted facial features with a reference facial feature data to identify the face.

Various embodiments of the systems and methods for identification and prioritization of one or more attributes described above enable an easy and fast access of a person's identity on a social media platform as the identity is detected by identifying a barcode or a face recognition technique. The system is less complex as compared to conventional system as the system prioritizes the search results in a predefined order.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for identification and prioritization of attributes of an image comprising:
capturing a digital image;
initially processing of the digital image;
identifying characteristics of the processed digital image such as a barcode, QR code or face; and
prioritizing the subsequent processing of the identified characteristics by processing the identified characteristics in a predefined order.

2. The system of claim 1, wherein the image is captured on a scanning device, a smartphone, or a web camera.

3. The system of claim 1, wherein the initial processing uses an edge detection technique, a Hough transformation, or a Bayesian technique.

4. The system of claim 1, wherein the predefined processing order processes a barcode or QR code before any other identified characteristic of the image.

5. The system of claim 1, wherein the predefined processing order processes facial recognition or image recognition after all other identified characteristics of the image.

6. The system of claim 1, wherein the captured digital image is captured from a social media platform.

7. The system of claim 1, wherein the captured digital image is communicated to the initial processing step via a communication network.

8. The system of claim 7, wherein the communication network is a wired local area network.

9. The system of claim 7, wherein the communication network is wireless.

10. The system of claim 9, wherein the wireless communication network uses a wireless protocol chosen from the group consisting of 2G, 3G, 4G, LTE, HSDPA, WiFi, Bluetooth, Zigbee, and Low Power WAN.

11. The system of claim 1, wherein image processing and characteristic identification occur on a cloud-based server accessed remotely.
